(19) United States
(12) Patent Application Publication
(10) Pub. No.: US 2025/0092543 A1
(43) Pub. Date: Mar. 20, 2025

(54) ELECTROCATALYSTS FOR THE OXYGEN EVOLUTION REACTION IN ACID CONDITIONS

(71) Applicant: Toyota Motor Engineering & Manufacturing North America, Inc, Plano, TX (US)

(72) Inventors: Siwen Wang, Ann Arbor, MI (US); Chen Ling, Troy, MI (US); Yui Wakabayashi, Ann Arbor, MI (US); Honghong Lin, Ann Arbor, MI (US); Li Q. Zhou, Okemos, MI (US); Charles Alexander Roberts, Farmington Hills, MI (US); Hongfei Jia, Ann Arbor, MI (US); Debasish Banerjee, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/469,596

(22) Filed: Sep. 19, 2023

(51) Int. Cl. C25B 11/075; C25B 1/04; C25B 9/17

(52) U.S. Cl. CPC C25B 11/075; C25B 1/04; C25B 9/17

(57) ABSTRACT

An oxygen evolution reduction electrocatalyst includes a pyrochlore compound with the chemical formula Sm₂Ru₂ₓM₂₋₂ₓO₇, where M is selected from the group consisting of Ir, Sc, Fe, Cu, Pd, Cr, and Rh, and x is less than 1.0 and greater than or equal to 0.5. Also, a water electrolysis cell includes an anode, a cathode, an electrolyte, and the oxygen evolution reduction electrocatalyst.

### TECHNICAL FIELD

The present disclosure generally relates to electrocatalysts, and particularly to electrocatalysts for the oxygen evolution reaction.

### BACKGROUND

Catalysts for the acidic oxygen evolution reaction (OER) play key roles in enabling use of technologies such as proton exchange membrane water electrolysis (PEMWE) systems for the production of hydrogen. However, costs associated with precious metals used to produce effective catalysts have inhibited wide scale commercialization of PEMWE systems.

The present disclosure addresses these issues with catalysts for the acidic OER, and other issues related to catalysts.

### SUMMARY

In one form of the present disclosure, an electrocatalyst includes a pyrochlore compound with the chemical formula Sm₂Ru₂ₓM₂₋₂ₓO₇, where M is selected from the group consisting of Ir, Sc, Fe, Cu, Pd, Cr, and Rh, and x is less than 1.0 and greater than or equal to 0.5.

In another form of the present disclosure, an electrocatalyst includes a pyrochlore compound with the chemical formula Sm₂Ru₂ₓM₂₋₂ₓO₇, where M is Cr and x is between about 0.5 and about 0.9.

In still another form of the present disclosure, a water electrolysis cell includes an anode, a cathode, an electrolyte, and an oxygen evolution reduction electrocatalyst in the form of a pyrochlore compound with the chemical formula Sm₂Ru₂ₓM₂₋₂ₓO₇ and where M is selected from the group consisting of Ir, Sc, Fe, Cu, Pd, Cr, and Rh, and x is less than 1.0 and greater than or equal to 0.5.

These and other features of the electrocatalyst will become apparent from the following detailed description when read in conjunction with the figures and examples, which are exemplary, not limiting.

### BRIEF DESCRIPTION OF THE DRAWINGS

The present teachings will become more fully understood from the detailed description and the accompanying drawings, wherein:

FIG. 1 shows a water electrolysis cell according to the teachings of the present disclosure;

FIG. 2A shows a crystal structure for a Sm₂(Ru)₂ₓM₂₋₂ₓO₇ pyrochlore compound with x=0.0 according to the teachings of the present disclosure;

FIG. 2B shows a crystal structure for a Sm₂(Ru)₂ₓM₂₋₂ₓO₇ pyrochlore compound with x=0.25 according to the teachings of the present disclosure;

FIG. 2C shows a crystal structure for a Sm₂(Ru)₂ₓM₂₋₂ₓO₇ pyrochlore compound with x=0.583 according to the teachings of the present disclosure;

FIG. 2D shows a crystal structure for a Sm₂(Ru)₂ₓM₂₋₂ₓO₇ pyrochlore compound with x=0.75 according to the teachings of the present disclosure;

FIG. 2E shows a crystal structure for a Sm₂(Ru)₂ₓM₂₋₂ₓO₇ pyrochlore compound with x=0.833 according to the teachings of the present disclosure;

FIG. 3 is a series of x-ray diffraction plots for Sm₂(Ru)₂ₓM₂₋₂ₓO₇ with varying amounts of dopant M;

FIG. 4 is a linear sweep voltammetry (LSV) plot showing current density measured at working electrodes loaded with RuO₂, Sm₂Ru₂O₇, and seven different doped Sm₂(Ru)₂ₓM₂₋₂ₓO₇ pyrochlore compounds according to the teachings of the present disclosure; and

FIG. 5 is a graphical plot of current density as a function of time measured at working electrodes loaded with RuO₂, Sm₂Ru₂O₇, and seven different doped Sm₂(Ru)₂ₓM₂₋₂ₓO₇ pyrochlore according to the teachings of the present disclosure.

It should be noted that the figures set forth herein is intended to exemplify the general characteristics of the methods, algorithms, and devices among those of the present technology, for the purpose of the description of certain aspects. The figures may not precisely reflect the characteristics of any given aspect and are not necessarily intended to define or limit specific forms or variations within the scope of this technology.

### DETAILED DESCRIPTION

The present disclosure provides electrocatalysts for the production of hydrogen from water, and particularly, electrocatalysts for catalyzing the OER in acidic conditions during the production of hydrogen gas (H₂ gas) from water (H₂O liquid). In some variations, an electrocatalyst according to the teachings of the present disclosure is a pyrochlore compound containing samarium (Sm), ruthenium (Ru), and at least one element selected from iridium (Ir), scandium (Sc), iron (Fe), copper (Cu), palladium (Pd), chromium (Cr), and rhodium (Rh). For example, in some variations the electrocatalysts include pyrochlore compounds with the chemical formula or composition Sm₂(Ru)₂ₓM₂₋₂ₓO₇, where M is a dopant selected from Ir, Sc, Fe, Cu, Pd, Cr, and/or Rh, and x is less than 1.0 and greater than or equal to 0.5.

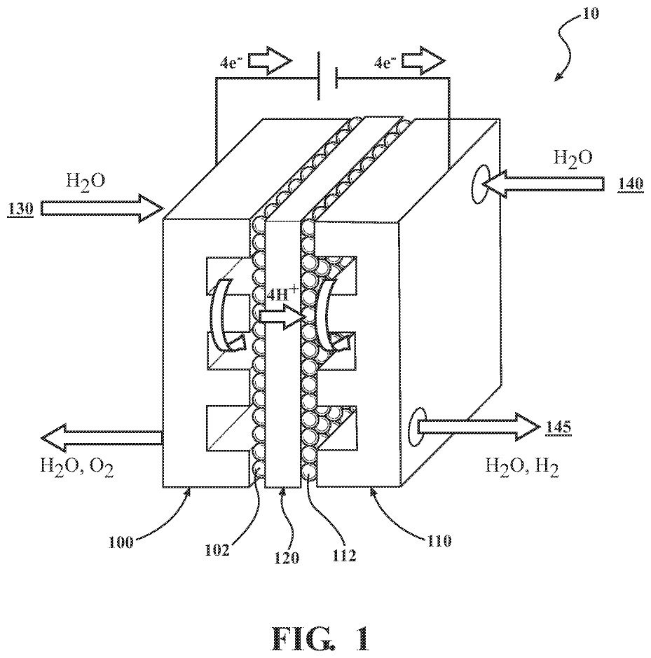

Referring to FIG. 1, a water electrolysis cell 10 for the production of hydrogen is shown. The cell includes an anode 100, an OER electrocatalyst 102, a cathode 110, a hydrogen evolution reaction electrocatalyst 112, and an electrolyte 120. The water electrolysis cell 10 also includes a water intake 130 and a water outlet 135 in fluid communication with the anode 100, and a water intake 140 and a hydrogen outlet 145 in fluid communication with the cathode 110. In some variations, the electrolyte 120 is polymer electrolyte membrane (PEM) and the water electrolysis cell 10 is a PEM electrolyzer.

In operation, electricity is provided via an external circuit (not shown) across the anode 100 and cathode 110 and water is fed or provided to the anode 100 via the water intake 130. The water is catalyzed by the OER electrocatalyst 102 into molecular oxygen and protons (positively charged hydrogen ions) per the OER:

2H₂O=>O₂+4H⁺+4e⁻.

And the electrons from the OER flow through the external circuit, the hydrogen ions selectively move/migrate across the electrolyte 120 to the cathode 110, and the hydrogen ions combine with the electrons at the cathode 110 to form hydrogen per the reaction:

4H⁺+4e⁻=>2H₂.

In some variations, acid is added to the water to increase ionization thereof such that the acidic water conducts electricity. However, the OER in acid conditions is relatively slow (sluggish), and to date, the OER electrocatalyst 102 relies on cost prohibitive (expensive) Ir- and Ru-based materials. Accordingly, any replacement of the Ir and/or Ru in the OER electrocatalyst 102 with less expensive elements is advantageous for green hydrogen production, i.e., the production of hydrogen via the electrolysis of water.

The OER electrocatalyst 102 according to the teachings of the present disclosure includes a pyrochlore compound with the composition or chemical formula Sm₂(Ru)₂ₓM₂₋₂ₓO₇, where M is at least one element selected from Ir, Sc, Fe, Cu, Pd, Cr, and Rh, and x is less than 1.0 and greater than or equal to 0.5. Accordingly, it should be understood that the pyrochlore compounds doped with M according to the teachings of the present disclosure are not pyrochlore compounds with incidental impurities in the parts per million (ppm) or parts per billion (ppb) range.

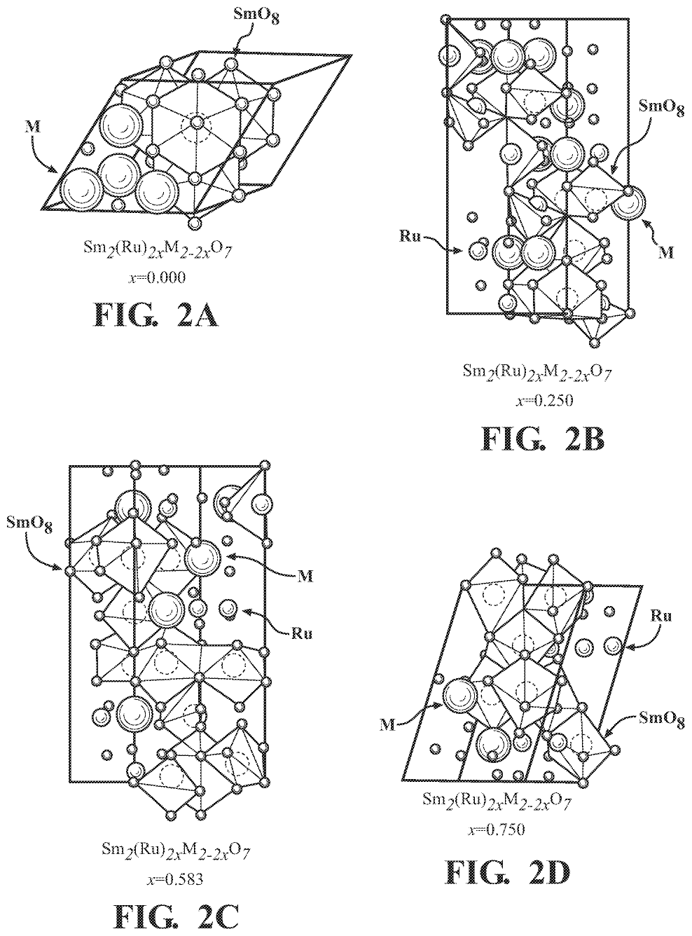

Referring to FIGS. 2A-2E, crystal structures for the pyrochlore compound Sm₂(Ru)₂ₓM₂₋₂ₓO₇ with x=0.000 (FIG. 2A), x=0.250 (FIG. 2B), x=0.583 (FIG. 2C), x=0.750 (FIG. 2D), and x=0.833 (FIG. 2E) are shown. In some variations, x is less than 1.0, e.g., less than or equal to 0.95 or less than or equal 0.90. And in at least one variation, x is less than or equal to 0.85. In addition, in some variations x is equal to or greater than 0.5, e.g., greater than or equal to 0.6, greater than or equal 0.7, or greater than or equal to 0.8.

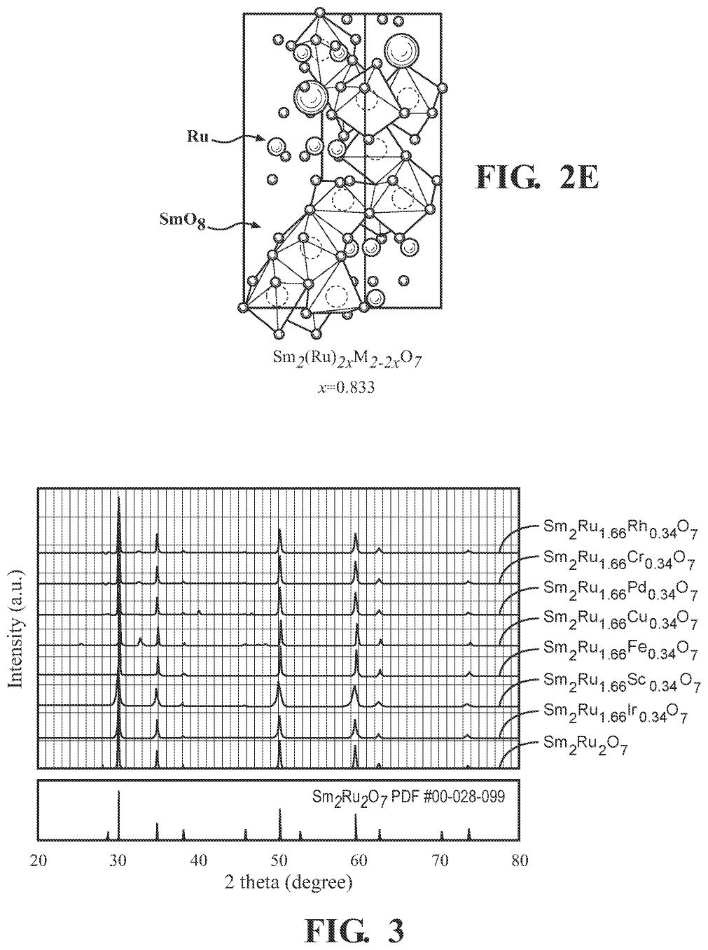

Referring now to FIG. 3, a graphical plot of intensity versus 2 theta for x-ray diffraction (XRD) analysis (scanning) of Sm₂Ru₂O₇ and seven (7) doped Sm₂(Ru)₂ₓM₂₋₂ₓO₇ compounds where x is equal to 0.83 is shown. Particularly, Sm₂Ru₂O₇, Sm₂Ru_{1.66}Rh_{0.34}O₇, Sm₂Ru_{1.66}Cr_{0.34}O₇, Sm₂Ru_{1.66}Pd_{0.34}O₇, Sm₂Ru_{1.66}Cu_{0.34}O₇, Sm₂Ru_{1.66}Fe_{0.34}O₇, Sm₂Ru_{1.66}Sc_{0.34}O₇, and Sm₂Ru_{1.66}Ir_{0.34}O₇ compounds were synthesized and evaluated with XRD. And as observed from FIG. 3, the seven doped Sm₂(Ru)₂ₓM₂₋₂ₓO₇ compounds exhibited or had the same pyrochlore crystal structure as the undoped Sm₂Ru₂O₇ compound.

The pyrochlore compounds were prepared using a sol-gel method adapted from the reference titled “High-Performance Pyrochlore-Type Yttrium Ruthenate Electrocatalyst for Oxygen Evolution Reaction in Acidic Media” by Kim et al., J. Am. Chem. Soc. 2017, 139 (34) 12076-12083, which is incorporated herein in its entirety by reference. For example, the Sm₂Ru₂O₇ compound was prepared by adding Sm(NO₃)₃ (1 mmol, 0.383 g), citric acid (0.84 g, 4.5 mol citric acid/mol A site), and ruthenium nitrosyl nitrate solution (1.5 wt % Ru, 1 mmol Ru, 6.18 mL) to 20 mL of deionized water and sonicating the solution for 10 min to fully dissolve the citric acid and metal nitrate in the deionized water. The resulting solution was then heated at about 80° C. while stirring at 400 rpm to evaporate the water, which took between 4 to 6 hours. The resulting rust-colored gel was further dried at about 90° C. overnight in an oven and the remaining solid was ground with a mortar and pestle to create a fine powder. The fine powder was transferred to a zirconia combustion boat and annealed in air at 600° C. (ramping rate 5° C./min) for 6 hours, cooled down to room temperature, reheated to 1000° C. (ramping rate of 5° C./min) for and kept at 1000° C. for 12 hours, and cooled to less than 60° C. before removing from the furnace. The resulting catalyst was ground again with a mortar and pestle. In addition, the seven doped Sm₂(Ru)₂ₓM₂₋₂ₓO₇ compounds were prepared similarly except for the stoichiometric amounts of respective transition metal nitrates and the ruthenium nitrosyl nitrate solution adjusted accordingly.

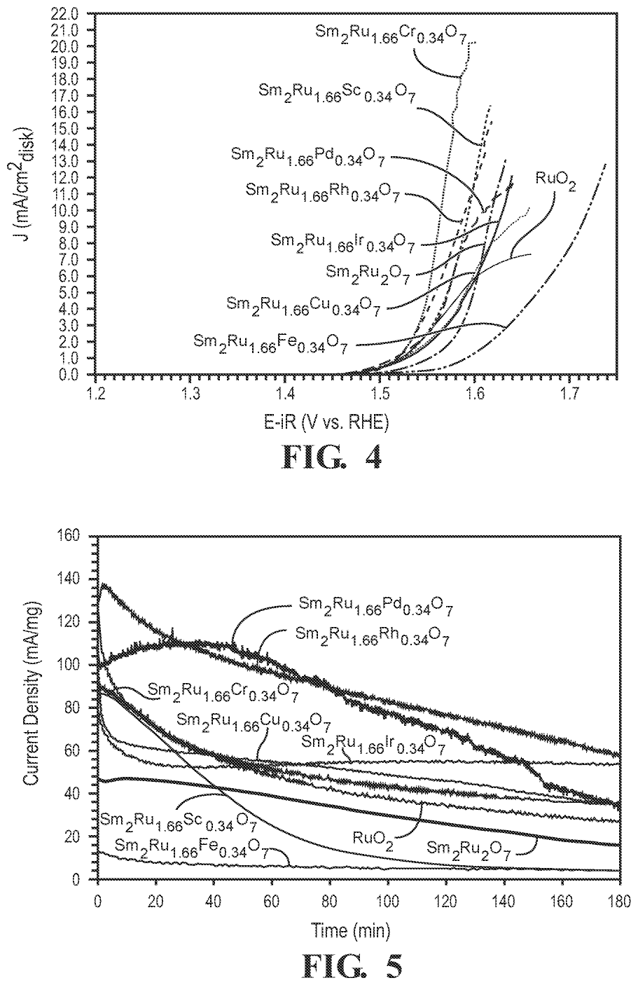

Referring to FIG. 4, results of linear sweep voltammetry (LSV) testing of RuO₂, Sm₂Ru₂O₇, and the seven doped Sm₂(Ru)₂ₓM₂₋₂ₓO₇ pyrochlore compounds are shown. Electrochemical measurements were carried out in a typical three-electrode cell using a reversible hydrogen electrode (RHE) as a reference electrode, a high surface area Pt wire as a counter electrode and a rotating ring-disk electrode (RDE) consisting of a 5 mm diameter glassy carbon as a working electrode. The working electrode contained 15 μg/cm² of a given electrocatalyst material (i.e., RuO₂, Sm₂Ru₂O₇, or one of the seven doped Sm₂(Ru)₂ₓM₂₋₂ₓO₇ pyrochlore compounds), and a potential scan rate of 1 mV/s was performed in the O₂-saturated 0.1 M HClO₄ solution at the rotation speed of 1600 rpm. The current was recorded when the potential was applied to the working electrode, which curve can be used to describe the catalytic activity. At the same potential, the higher current density, the more active the catalyst; at the same current density, the smaller potential, the more active the catalyst.

Still referring to FIG. 4, the general order of performance (catalytic activity) from the highest to the lowest was Sm₂Ru_{1.66}Cr_{0.34}O₇, Sm₂Ru_{1.66}Rh_{0.34}O₇, Sm₂Ru_{1.66}Sc_{0.34}O₇, Sm₂Ru_{1.66}Pd_{0.34}O₇, Sm₂Ru_{1.66}Cr_{0.34}O₇, Sm₂Ru_{1.66}Ir_{0.34}O₇, Sm₂Ru_{1.66}Cu_{0.34}O₇, Sm₂Ru₂O₇, and Sm₂Ru_{1.66}Fe_{0.34}O₇. The most active Sm₂Ru_{1.66}Cr_{0.34}O₇ reached 10.0 mA/cm² at 1.565 V, compared to the 1.62 V at 10.0 mA/cm² of Sm₂Ru₂O₇. Sm₂Ru_{1.66}Cr_{0.34}O₇ also outperformed the compounds with more expensive dopants (i.e. Rh, Pd, Ir).

Accordingly, it should be understood that the doped pyrochlore compounds according to the teachings of the present disclosure exhibit enhanced catalytic activity compared to Sm₂Ru₂O₇. For example, in some variations the doped pyrochlore compounds according to the teachings of the present disclosure exhibit a 10.0 mA/cm² current density for an applied potential that is at least 40 millivolts less than the applied potential for undoped Sm₂Ru₂O₇. And in at least one variation, the doped pyrochlore compounds according to the teachings of the present disclosure exhibit a 10.0 mA/cm² current density for an applied potential that is at least 50 millivolts less than the applied overpotential for undoped Sm₂Ru₂O₇.

Referring to FIG. 5, the durability test of RuO₂, Sm₂Ru₂O₇, and the seven doped Sm₂(Ru)₂ₓM₂₋₂ₓO₇ pyrochlore compounds was performed by applying 1.53 volts to the working electrode, when the current density of the working electrode was recorded in variance of time. That is, FIG. 5 shows how the catalyst's activity changed over time. For each test, the working electrode contained 15 μg/cm² of RuO₂, Sm₂Ru₂O₇, or the seven doped Sm₂(Ru)₂ₓM₂₋₂ₓO₇ pyrochlore compounds, the electrolyte/solution was O₂-saturated 0.1 M HClO₄ rotated at 1600 rpm, The doped pyrochlore compounds—Sm₂Ru_{1.66}Cr_{0.34}O₇, Sm₂Pd_{1.66}Cr_{0.34}O₇, Sm₂Ru_{1.66}Cr_{0.34}O₇, Sm₂Ru_{1.66}Rh_{0.34}O₇, Sm₂Ru_{1.66}Sc_{0.34}O₇, and Sm₂Ru_{1.66}Ir_{0.34}O₇, also showed better durability than Sm₂Ru₂O₇. Particularly, Sm₂Ru_{1.66}Cr_{0.34}O₇ had a mass activity of ˜58 mA/mg after holding at 1.53 V for 3 hours while Sm₂Ru₂O₇ only had ˜18 mA/mg.

Accordingly, the doped pyrochlore compounds according to the teachings of the present disclosure exhibit enhanced durability compared to the undoped Sm₂Ru₂O₇. For example, in some variations one or more of the doped pyrochlore compounds according to the teachings of the present disclosure exhibit at least a 200% increase in current density after 3 hours and an applied potential of 1.53 volts compared to undoped Sm₂Ru₂O₇. And in at least one variation, one or more of the doped pyrochlore compounds according to the teachings of the present disclosure exhibit at least a 300% increases in current density after 3 hours and an applied potential of 1.53 volts compared to undoped Sm₂Ru₂O₇.

In view of the above teachings, it should be understood that the doped Sm₂(Ru)₂ₓM₂₋₂ₓO₇ pyrochlore compounds according to the teachings of the present disclosure provide or exhibit enhanced OER catalytic activity in acid conditions. In addition, use of the that the doped Sm₂(Ru)₂ₓM₂₋₂ₓO₇ pyrochlore compounds according to the teachings of the present disclosure in PEMWE systems for the production of hydrogen provides or results in enhanced performance of such PEMWE systems.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple forms or variations having stated features is not intended to exclude other forms or variations having additional features, or other forms or variations incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should also be understood that the various method steps discussed herein do not have to be carried out in the same order as depicted, and not each method step is required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. An electrocatalyst comprising:
a pyrochlore compound with the chemical formula Sm₂Ru₂ₓM₂₋₂ₓO₇ where M is selected from the group consisting of Ir, Sc, Fe, Cu, Pd, Cr, and Rh, and x is less than 1.0 and greater than or equal to 0.5.

2. The electrocatalyst according to claim 1, wherein M is selected from the group consisting of Sc, Pd, Cr, and Rh.

3. The electrocatalyst according to claim 2, wherein M is Cr.

4. The electrocatalyst according to claim 3, wherein x is between about 0.5 and about 0.9.

5. The electrocatalyst according to claim 4, wherein x is between about 0.6 and about 0.9.

6. The electrocatalyst according to claim 5, wherein x is between about 0.7 and about 0.9.

7. The electrocatalyst according to claim 3, wherein the pyrochlore compound at a 10.0 mA/cm² current density exhibits an overpotential at least 40 millivolts less than Sm₂Ru₂O₇ at the 10.0 mA/cm² current density.

8. The electrocatalyst according to claim 7, wherein the overpotential is at least 50 millivolts less than Sm₂Ru₂O₇ at the 10.0 mA/cm² current density.

9. The electrocatalyst according to claim 3, wherein the pyrochlore compound at an overpotential equal to 1.53 V relative to a reversible hydrogen electrode exhibits a current density at least 25 mA/mg² greater than a current density exhibited by Sm₂Ru₂O₇ at the overpotential equal to 1.53 V relative to a reversible hydrogen electrode.

10. The electrocatalyst according to claim 9, wherein the current density exhibited by the pyrochlore compound is at least 35 mA/mg² greater than the current density exhibited by Sm₂Ru₂O₇.

11. The electrocatalyst according to claim 1, wherein M is Cr and at a 10.0 mA/cm² current density the pyrochlore compound exhibits an overpotential less than an overpotential of the pyrochlore compounds with M being Rh, Sc, Pd, Ir, Cu, or Fe.

12. The electrocatalyst according to claim 1, wherein M is Cr and the pyrochlore compound at an overpotential equal to 1.53 V relative to a reversible hydrogen electrode exhibits a current density greater than a current density of the pyrochlore compounds with M being Rh, Sc, Pd, Ir, Cu, or Fe.

13. An electrocatalyst comprising:
a pyrochlore compound with the chemical formula Sm₂Ru₂ₓM₂₋₂ₓO₇, where M is Cr and x is between about 0.5 and about 0.9.

14. The electrocatalyst according to claim 13, wherein x is between about 0.6 and about 0.9.

15. The electrocatalyst according to claim 14, wherein x is between about 0.7 and about 0.9.

16. The electrocatalyst according to claim 13, wherein the pyrochlore compound at a 10.0 mA/cm² current density exhibits an overpotential at least 40 millivolts less than Sm₂Ru₂O₇ at the 10.0 mA/cm² current density.

17. The electrocatalyst according to claim 16, wherein the overpotential is at least 50 millivolts less than Sm₂Ru₂O₇ at the 10.0 mA/cm² current density.

18. The electrocatalyst according to claim 13, wherein the pyrochlore compound at an overpotential equal to 1.53 V relative to a reversible hydrogen electrode exhibits a current density at least 35 mA/cm² greater than a current density exhibited by Sm₂Ru₂O₇ at the overpotential equal to 1.53 V relative to the reversible hydrogen electrode.

19. A water electrolysis cell comprising:
an anode;
a cathode;
an electrolyte; and
an oxygen evolution reduction electrocatalyst comprising a pyrochlore compound with the chemical formula Sm₂Ru₂ₓM₂₋₂ₓO₇, where M is selected from the group consisting of Ir, Sc, Fe, Cu, Pd, Cr, and Rh, and x is less than 1.0 and greater than or equal to 0.5.

20. The water electrolysis cell according to claim 19, wherein M is Cr, x is between about 0.5 and about 0.9, and the pyrochlore compound exhibits a 10.0 mA/cm² current density for an applied potential that is at least 40 millivolts less than an applied potential for undoped Sm₂Ru₂O₇.
